(19) United States
(12) Patent Application Publication
(10) Pub. No.: US 2024/0206450 A1
(43) Pub. Date: Jun. 27, 2024

(54) SYSTEM AND METHOD FOR AN AGRICULTURAL APPLICATOR

(71) Applicant: CNH Industrial America LLC, New Holland, PA (US)

(72) Inventor: Kevin M. Smith, Narvon, PA (US)

(21) Appl. No.: 18/085,905

(22) Filed: Dec. 21, 2022

(51) Int. Cl. A01M 7/00

(52) U.S. Cl. CPC A01M 7/0089; A01M 7/0042

(57) ABSTRACT

An agricultural system can include a product application system including a first set of nozzle assemblies and a second set of nozzle assemblies. A target sensor can be configured to capture data indicative of one or more features within a field. A computing system can be communicatively coupled to the product application system and the target sensor. The computing system can be configured to activate the first set of nozzle assemblies to apply an agricultural product to an underlying field, identify a target within the field based on the data from the target sensor, determine a characteristic of the target, compare the characteristic of the target to a defined threshold, and activate at least one nozzle assembly of the second set of nozzle assemblies when the characteristic of the target is varied from the defined threshold.

### FIELD

The present disclosure generally relates to agricultural implements and, more particularly, to systems and methods for spray operations, such as by monitoring and/or altering a flow condition of an agricultural product during the spray operation.

### BACKGROUND

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, agricultural product, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom sections, each with a number of spray nozzles (also sometimes referred to as spray tips).

The spray nozzles on the boom assembly disperse the agricultural product carried by the applicator onto a field. During a spray operation, however, various factors may affect a quality of the application of the agricultural product to the field. Accordingly, an improved system and method for monitoring the quality of application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system that includes a product application system including a first set of nozzle assemblies and a second set of nozzle assemblies. A target sensor is configured to capture data indicative of one or more features within a field. A computing system is communicatively coupled to the product application system and the target sensor. The computing system is configured to activate the first set of nozzle assemblies to apply an agricultural product to an underlying field, identify a target within the field based on the data from the target sensor, determine a characteristic of the target, compare the characteristic of the target to a defined threshold, and activate at least one nozzle assembly of the second set of nozzle assemblies when the characteristic of the target is varied from the defined threshold and the target is within a fan of the at least one nozzle assembly of the second set of nozzle assemblies to apply a combined volume of agricultural product from the first set of nozzle assemblies and the second set of nozzle assemblies.

In some aspects, the present subject matter is directed to a method for an agricultural application operation. The method includes activating, with a computing system, a first set of nozzle assemblies to apply an agricultural product to an underlying field. The method also includes identifying, with the computing system, a target within the field based on data from a target sensor. The method further includes determining, with the computing system, a characteristic of the target based at least partially on the data from the target sensor. The method further includes comparing, with the computing system, the characteristic of the target to a defined threshold. Lastly, the method includes determining, with the computing system, a time in which a fan of the agricultural product from at least one nozzle assembly of a second set of nozzle assemblies is aligned with the target.

In some aspects, the present subject matter is directed to an agricultural system that includes a product application system including a first set of nozzle assemblies configured to continuously apply an agricultural product to an underlying field during a spray operation. The system also includes a second set of nozzle assemblies. A target sensor is configured to capture data indicative of one or more features within a field. A computing system is communicatively coupled to the product application system and the target sensor. The computing system is configured to identify a target within the field based on the data from the target sensor, determine a characteristic of the target relative to a defined threshold, and activate at least one nozzle assembly of the second set of nozzle assemblies when the characteristic of the target is varied from the defined threshold and the target is within a fan of the at least one nozzle assembly of the second set of nozzle assemblies.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural work vehicle in accordance with aspects of the present subject matter;

FIG. 2 illustrates a side view of the work vehicle in accordance with aspects of the present subject matter;

FIG. 3 is a rear partial view of a boom arm of the vehicle in accordance with aspects of the present subject matter;

FIG. 4 illustrates a block diagram of components of the agricultural applicator system in accordance with aspects of the present subject matter;

FIG. 5 is a rear partial view of the boom arm of the vehicle in accordance with aspects of the present subject matter;

FIG. 6 is a rear partial view of the boom arm of the vehicle in accordance with aspects of the present subject matter; and

FIG. 7 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises . . . a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component's ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless specifically identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to an agricultural system that can include a product application system. The product application system can include a first set of nozzle assemblies and a second set of nozzle assemblies that are each fluidly coupled with a tank that retains an agricultural product.

A target sensor can be configured to capture data indicative of one or more features within a field. the target sensor may be configured to capture data indicative of various features within the field. For example, the target sensor may be able to capture data indicative of objects and/or field conditions. For instance, in some embodiments, the target sensor can be feature detecting/identifying imaging devices, where the data captured by the target sensor may be indicative of the location and/or type of plants and/or other objects within the field. More particularly, in some embodiments, the data captured by the target sensor 80 may be used to allow various objects to be detected. In some cases, the data captured may allow the computing system to distinguish weeds from useful plants within the field (e.g., crops).

A computing system can be communicatively coupled to the product application system and the target sensor. The computing system can be configured to activate the first set of nozzle assemblies to apply an agricultural product to an underlying field, which may be applied in a generally continuous manner. The computing system may also identify a target within the field based on the data from the target sensor, determine a characteristic of the target, compare the characteristic of the target to a defined threshold, and activate at least one nozzle assembly of the second set of nozzle assemblies when the characteristic of the target is varied from the defined threshold and the target is within a fan of the at least one nozzle assembly of the second set of nozzle assemblies to apply a combined volume of agricultural product from the first set of nozzle assemblies and the second set of nozzle assemblies.

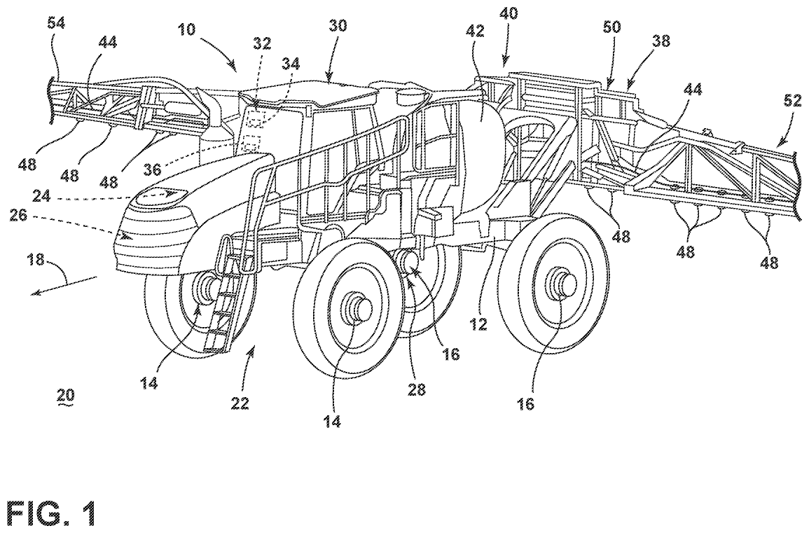

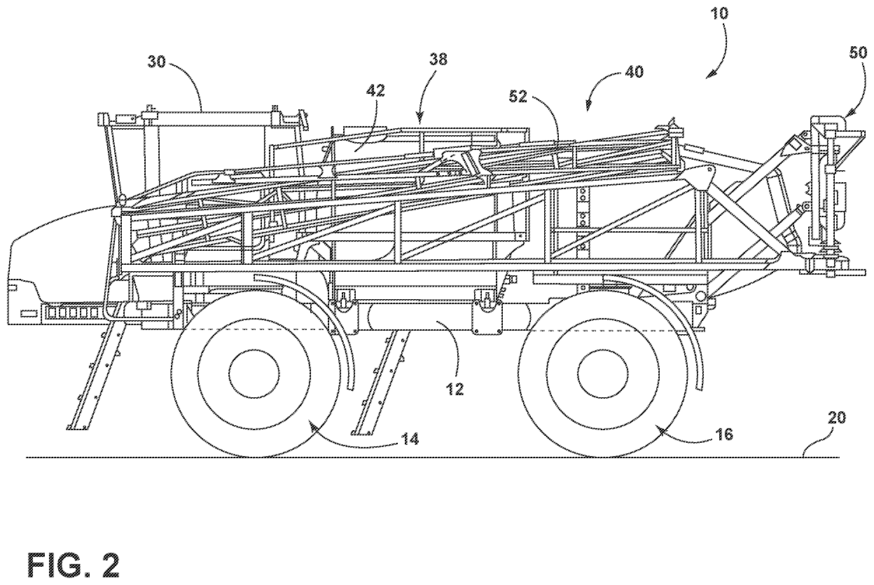

Referring now to FIGS. 1 and 2, a work vehicle 10 is generally illustrated as a self-propelled agricultural applicator. However, in alternate embodiments, the work vehicle 10 may be configured as any other suitable type of work vehicle 10 configured to perform agricultural application operations, such as a tractor or other vehicle configured to haul or tow an application implement.

In various embodiments, the work vehicle 10 may include a chassis 12 configured to support or couple to a plurality of components. For example, front and rear wheels 14, 16 may be coupled to the chassis 12. The wheels 14, 16 may be configured to support the work vehicle 10 relative to a field 20 and move the work vehicle 10 in a direction of travel (e.g., as indicated by arrow 18 in FIG. 1) across the field 20. In this regard, the work vehicle 10 may include a powertrain control system 22 that includes a power plant 24, such as an engine, a motor, or a hybrid engine-motor combination, a hydraulic propel or transmission system 26 configured to transmit power from the engine to the wheels 14, 16, and/or a brake system 28.

The chassis 12 may also support a cab 30, or any other form of user's station, for permitting the user to control the operation of the work vehicle 10. For instance, as shown in FIG. 1, the work vehicle 10 may include a user interface 32 having a display 34 for providing messages and/or alerts to the user and/or for allowing the user to interface with the vehicle's controller through one or more user input devices 36 (e.g., levers, pedals, control panels, buttons, and/or the like).

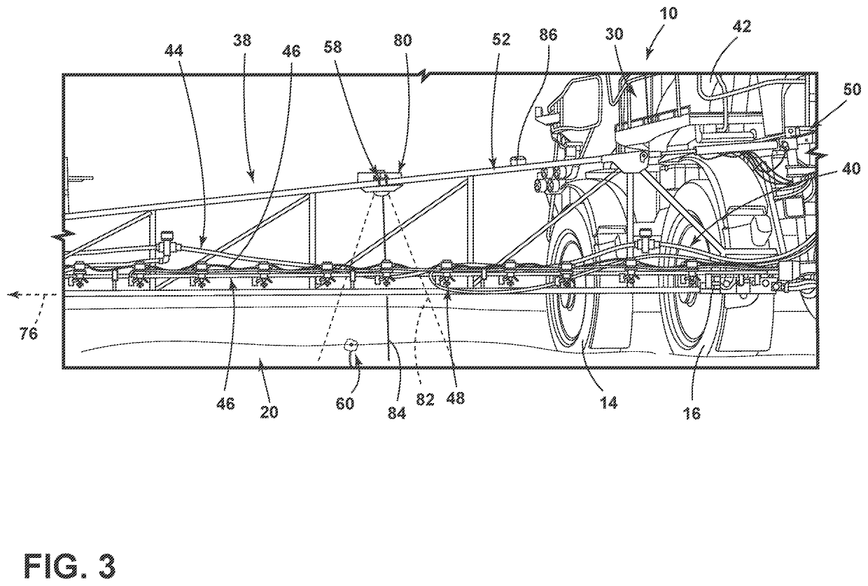

The chassis 12 may also support a boom assembly 38 mounted to the chassis 12. In addition, the chassis 12 may support a product application system 40 that includes one or more tanks 42, such as a rinse tank and/or a product tank. The product tank may be generally configured to store or hold an agricultural product, such as a pesticide, a fungicide, a rodenticide, a nutrient, and/or the like. The agricultural product is conveyed from the product tank through plumbing components, such as interconnected pieces of conduit 44 and/or one or more headers 46 (FIG. 3), for release onto the underlying field 20 (e.g., plants and/or soil) through nozzle assemblies 48 (e.g., by controlling the nozzle valves using a pulse width modulation (PWM) technique).

As shown in FIGS. 1 and 2, the boom assembly 38 can include a frame 50 that supports first and second boom arms 52, 54, which may be orientated in a cantilevered nature. The first and second boom arms 52, 54 are generally movable between an operative or unfolded position (FIG. 1) and an inoperative or folded position (FIG. 2). When distributing the product, the first and/or second boom arm 52, 54 extends laterally outward from the work vehicle 10 to cover swaths of the underlying field 20, as illustrated in FIG. 1. However, to facilitate transport, each boom arm 52, 54 of the boom assembly 38 may be independently folded forwardly or rearwardly into the inoperative position, thereby reducing the overall width of the vehicle 10, or in some examples, the overall width of a towable implement when the applicator is configured to be towed behind the work vehicle 10.

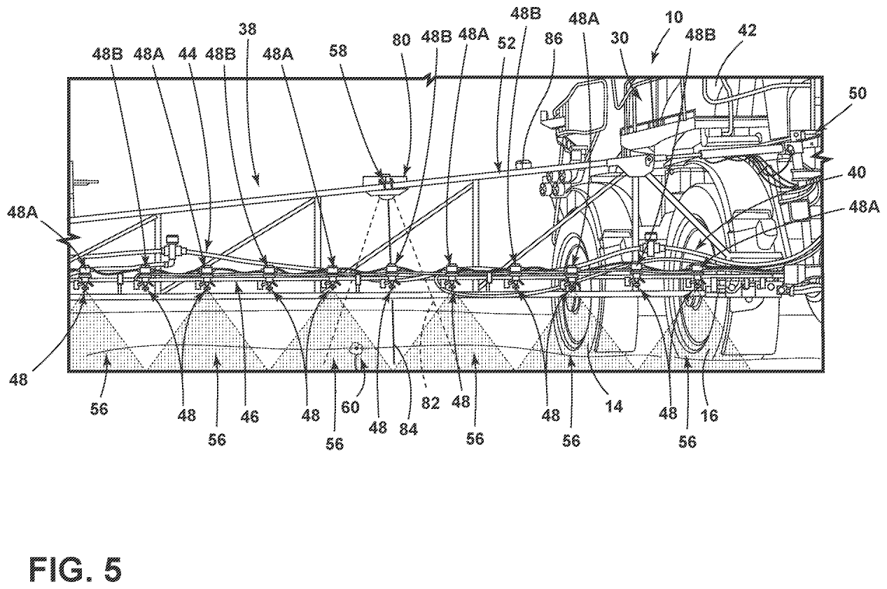

Referring to FIG. 3, the boom assembly 38 may be configured to support a plurality of nozzle assemblies 48. Each nozzle assembly 48 may be configured to dispense an agricultural product stored within the tank 42 onto the underlying field 20. In several embodiments, fluid conduits 44 and/or headers 46 may fluidly couple the nozzle assemblies 48 to the tank 42. In this respect, as the work vehicle 10 travels across the field 20 in the direction of travel 18 to perform a spray operation thereon, the agricultural product moves from the tank 42 through the fluid conduits 44 and/or headers 46 to each of the nozzle assemblies 48. The nozzle assemblies 48 may, in turn, dispense or otherwise spray a fan 56 (FIG. 5) of the agricultural product onto the underlying field 20.

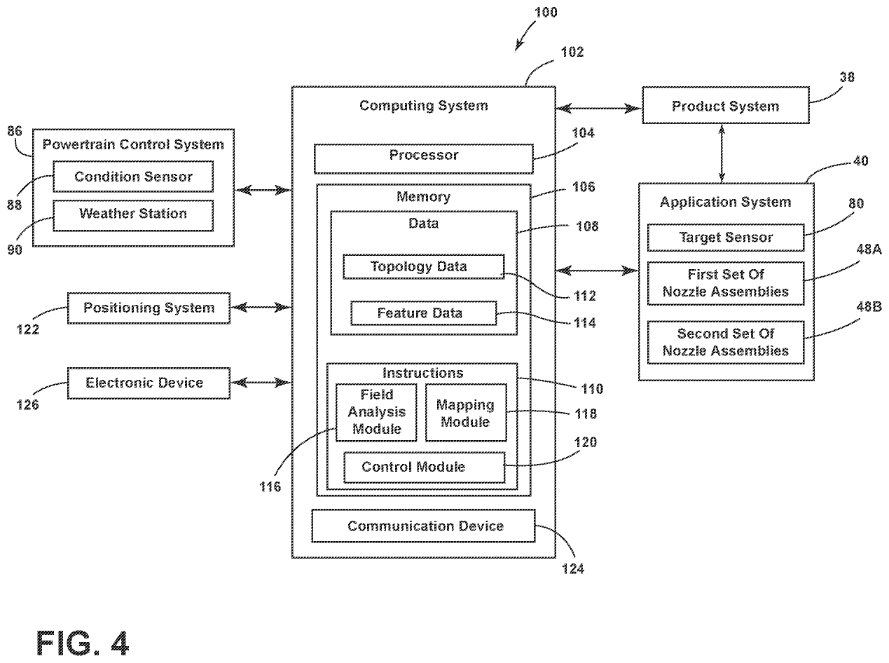

Referring further to FIG. 3, the boom assembly 38 may further include one or more target sensors 80 configured to capture data indicative of various features within the field 20. In several embodiments, the target sensor 80 may be installed or otherwise positioned on one or more boom arms 52, 54 of the boom assembly 38 through one or more brackets 58. Furthermore, each target sensor 80 may have a field of view or detection zone 82 (e.g., as indicated by dashed lines in FIG. 3) that is generally defined by a focal axis 84. In this regard, each target sensor 80 may be able to capture data indicative of objects and/or field conditions within its detection zone 82. For instance, in some embodiments, the target sensor 80 are feature detecting/identifying imaging devices, where the data captured by the target sensor 80 may be indicative of the location and/or type of plants and/or other objects within the field 20. More particularly, in some embodiments, the data captured by the target sensor 80 may be used to allow various objects to be detected. For example, the data captured may allow a computing system 102 (FIG. 4) to distinguish weeds from useful plants within the field 20 (e.g., crops). In such instances, the target sensor data may, for instance, be used within a spraying operation to selectively spray or treat a defined target 60, which may include the detected/identified weeds (e.g., with a suitable herbicide) and/or the detected/identified crops (e.g., with a nutrient). In addition, the data captured may allow a computing system 102 to identify one or more landmarks. In various embodiments, the landmarks may include a tree, a tree line, a building, a tower, and/or the like that may be proximate and/or within the field 20.

It should be appreciated that the agricultural sprayer 10 may include any suitable number of target sensors 80 and should not be construed as being limited to the number of target sensors 80 shown in FIG. 3. Additionally, it should be appreciated that the target sensor 80 may generally correspond to any suitable sensing devices. For example, each target sensor 80 may correspond to any suitable camera, such as single-spectrum camera or a multi-spectrum camera configured to capture images, for example, in the visible light range and/or infrared spectral range. Additionally, in various embodiments, the cameras may correspond to a single lens camera configured to capture two-dimensional images or a stereo cameras having two or more lenses with a separate image imaging device for each lens to allow the cameras to capture stereographic or three-dimensional images. Alternatively, the target sensor 80 may correspond to any other suitable image capture devices and/or other imaging devices capable of capturing “images” or other image-like data of the field 20. For example, the target sensor 80 may correspond to or include radio detection and ranging (RADAR) sensors, light detection and ranging (LIDAR) sensors, and/or any other practicable device.

With further reference to FIG. 3, in some examples, a first set 48A of nozzle assemblies 48 and a second set 48B of nozzle assemblies 48 may each be fluidly coupled with the tank 42 through the fluid conduits 44 and/or the headers 46. In some instances, the first set 48A of nozzle assemblies 48 and the second set 48B of nozzle assemblies 48 may be operably coupled with a common header 46. Additionally or alternatively, the first of nozzle assemblies 48 may be operably coupled with a first header 46 and the second set 48B of nozzle assemblies 48 may be operably coupled with a second header 46. In some instances, nozzle spacing, nozzle angle, and boom height can be configured so that both the first set 48A of nozzle assemblies 48 and the second set 48B of nozzle assemblies 48 can provide complete coverage of the underlying field 20 independent of the other set. For instance, in some examples, each nozzle assembly 48 can be a 110-degree nozzle with 20-inch nozzle spacing, spraying about 20 inches above the field 20 and/or the crops.

During operation, the first set 48A of nozzle assemblies 48 may be configured to apply the agricultural product along the boom assembly 38 to the underlying field 20 within a defined application rate range. When a target 60 is identified in the field 20, a characteristic of the target 60 may be calculated. If the calculated characteristic of the target 60 exceeds a defined threshold, at least one of the second set 48B of nozzle assemblies 48 may exhaust additional agricultural product to supplement the agricultural product being delivered onto the underlying field 20 by the first set 48A of nozzle assemblies 48. In various examples, the characteristic of the target can include a size of the target, a plant species (e.g., grass or broadleaf) within the target, a plant maturity of the target, a plant color (e.g., level of chlorophyll in leaves indicating vigorousness of plant) of the target, a plant location relative to crop (e.g., between corn rows or within a corn row) of the target, and/or any other identifiable characteristic. In addition, the size of the target may be a detected height of the target, a maximum width of the target, a surface area of the target, and/or any other quantifiable metric.

In some cases, a location of the target 60 relative to the boom assembly 38 along a lateral direction and a position of the target 60 to at least one nozzle assembly 48 of the second set 48B of nozzle assemblies 48 in a fore-aft direction may be determined to define a nozzle activation time and a specific nozzle assembly 48 of the second set 48B of nozzle assemblies 48 by a computing system 102 (FIG. 4). In some cases, a nozzle assembly 48 from the first set 48A of nozzle assemblies 48 can increase the spray rate in addition to activating a nozzle assembly 48 from the second set 48B of nozzle assemblies 48.

In various examples, each nozzle assembly 48 can include variable rate nozzle control (such as for herbicide treatment) using PWM controlled nozzles. However, such nozzles may not have a wide enough adjustment range in application rates to meet the defined application rate range. As such, the supplemental agricultural product provided by the second set 48B of nozzle assemblies 48 can provide the additional agricultural product to treat the defined target 60.

Referring now to FIG. 4, a schematic view of a system 100 for operating the vehicle 10 is illustrated in accordance with aspects of the present subject matter. In general, the system 100 will be described with reference to the vehicle 10 described above with reference to FIGS. 1-3. However, it should be appreciated by those of ordinary skill in the art that the disclosed system 100 may generally be utilized with agricultural machines having any other suitable machine configuration. Additionally, it should be appreciated that, for purposes of illustration, communicative links, or electrical couplings of the system 100 shown in FIG. 4 are indicated by arrows.

As shown in FIG. 4, the system 100 may include a computing system 102 operably coupled with the product application system 40. As provided herein, the product application system 40 can include a target sensor 80, the first set 48A of nozzle assemblies 48, and the second set 48B of nozzle assemblies 48. In operation, while applying an agricultural product to the field 20 by exhausting the agricultural product from the first set 48A of nozzle assemblies 48, the computing system 102 may identify a target 60 (FIG. 3) based on data generated by the target sensor 80. The computing system 102 may also determine a size (e.g., area within image data) of the target 60 (FIG. 3), which may be compared to a defined threshold. If the characteristic of the target 60 (FIG. 3) exceeds the defined threshold, the computing system 102 may determine a location of the target 60 (FIG. 3) relative to the second set 48B of nozzle assemblies 48 along the boom assembly 38. Based on the location of the target 60 (FIG. 3) relative to the second set 48B of nozzle assemblies 48 along the boom assembly 38, a nozzle assembly 48 within the second set 48B of nozzle assemblies 48 may be activated to apply the supplemental agricultural product to the target 60 (FIG. 3).

In general, the computing system 102 may comprise any suitable processor-based device, such as a computing device or any suitable combination of computing devices. Thus, in several embodiments, the computing system 102 may include one or more processors 104 and associated memory 106 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 106 of the computing system 102 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 106 may generally be configured to store information accessible to the processor 104, including data 108 that can be retrieved, manipulated, created, and/or stored by the processor 104 and instructions 110 that can be executed by the processor 104, when implemented by the processor 104, configure the computing system 102 to perform various computer-implemented functions, such as one or more aspects of the image processing algorithms and/or related methods described herein. In addition, the computing system 102 may also include various other suitable components, such as a communications circuit or module, one or more input/output channels, a data/control bus, and/or the like.

In various embodiments, the computing system 102 may correspond to an existing controller of the agricultural vehicle 10, or the computing system 102 may correspond to a separate processing device. For instance, in some embodiments, the computing system 102 may form all or part of a separate plug-in module or computing device that is installed relative to the vehicle 10 or the boom assembly 38 to allow for the disclosed system 100 and method to be implemented without requiring additional software to be uploaded onto existing control devices of the vehicle 10 or the boom assembly 38. Further, the various functions of the computing system 102 may be performed by a single processor-based device or may be distributed across any number of processor-based devices, in which instance such devices may be considered to form part of the computing system 102. For instance, the functions of the computing system 102 may be distributed across multiple application-specific controllers.

In various embodiments, the memory device(s) 106 of the computing system 102 may include one or more databases for storing information. For instance, as shown in FIG. 4, the memory device(s) 106 may include a topology database 112 storing data received from the one or more target sensors 80. For instance, topology data may be captured while the field 20 is in a pre-emergence condition (e.g., prior to a seed planting operation in the field 20 or following such operation but prior to the emergence of the plants). Additionally or alternatively, the memory device(s) 106 may include a feature database 114 storing feature data associated with the field 20. For instance, the feature data may be raw or processed data of one or more portions of the field 20. The feature database 114 may also store various forms of data that a related to the identified objects within and/or proximate to the field 20. For example, the objects may include targets 60 (FIG. 3) and/or landmarks that may be used to relocate the target 60 (FIG. 3) during a subsequent operation.

Referring still to FIG. 4, in several embodiments, the instructions stored within the memory device(s) 106 of the computing system 102 may be executed by the processor(s) 104 to implement a field analysis module 116. In general, the field analysis module 116 may be configured to analyze the feature data from the one or more target sensors 80 to allow the computing system 102 to identify one or more objects, such as a target 60 (FIG. 3) and/or a landmark, within the field 20. For instance, in several embodiments, the field analysis module 116 may be configured to analyze/process the data to detect/identify the type of various objects in the field 20. In this regard, the computing system 102 may include any suitable image or other data processing algorithms stored within its memory 106 or may otherwise use any suitable image processing techniques to determine, for example, the presence of a target 60 (FIG. 3) within the field 20 based on the feature data. For instance, in some embodiments, the computing system 102 may be able to distinguish between weeds and emerging/standing crops. Additionally or alternatively, in some embodiments, the computing system 102 may be configured to distinguish between weeds and emerging/standing crops, such as by identifying crop rows of emerging/standing crops and then inferring that plants positioned between adjacent crop rows are weeds. In some examples, the computing system 102 may also be able to determine a size (e.g., a height, a width, a surface area, etc.) of the identified weeds and compare the size to a defined threshold.

Additionally or alternatively, the field analysis module 116 may be configured to analyze the topology data to create a topology map. In some instances, the field analysis module 116 may also predict a likelihood of a presence of a weed and/or weeds of a general size at various locations within the field 20 based on the topology.

Moreover, the instructions stored within the memory device(s) 106 of the computing system 102 may be executed by the processor(s) 104 to implement a mapping module 118 that is configured to generate one or more maps of the field 20 based on the feature data and/or the topology data. It should be appreciated that, as used herein, a “map” may generally correspond to any suitable dataset that correlates data to various locations within a field 20. Thus, for example, a map may simply correspond to a data table that correlates field contour or topology data to various locations within the field 20 or may correspond to a more complex data structure, such as a geospatial numerical model that can be used to identify various objects in the feature data and/or topology data and determine a position of each object within the field 20, which may, for instance, then be used to generate a graphically displayed map or visual indicator.

In various examples, the computing system 102 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 102 and may be used to generate a predictive evaluation of the field 20 within the field analysis module 116 and/or the mapping module 118. In some instances, the machine learning engine may allow for changes to the field analysis module 116 and/or the mapping module 118 to be updated without human intervention.

Referring still to FIG. 4, in some embodiments, the instructions 216 stored within the memory 212 of the computing system 102 may also be executed by the processor(s) 104 to implement a control module 120. In general, the control module 120 may be configured to electronically control the operation of one or more components of the product application system 40. For instance, the computing system 102 may identify a target 60 (FIG. 3), a size (e.g., a height, a maximum width, a surface area, etc.) of the identified target 60 (FIG. 3) relative to a defined threshold, and/or a location of the target 60 (FIG. 3) relative to the boom assembly 38 based on data generated by the target sensor 80. Based on the identified target 60 (FIG. 3), the characteristic of the target 60 (FIG. 3), and the location of the target 60 (FIG. 3), the computing system 102 may activate nozzle assemblies 48 within the second set 48B of nozzle assemblies 48 while the first set 48A of nozzle assemblies 48 continuously exhausts agricultural product onto the underlying field 20. In some cases, the computing system 102 may be configured to activate at least one nozzle assembly 48 of the second set 48B of nozzle assemblies 48 when the combined volume of at least one nozzle of the first set 48A of nozzle assemblies 48 and at least one nozzle of the second set 48B of nozzle assemblies 48 is greater than a maximum volume exhausted from the at least one nozzle assembly 48 within first set 48A of nozzle assemblies 48.

In some instances, the computing system 102 may be communicatively coupled to a positioning system 122 that is configured to determine the location of the vehicle 10 by using a GPS system, a Galileo positioning system, the Global Navigation satellite system (GLONASS), the BeiDou Satellite Navigation and Positioning system, a dead reckoning system, and/or the like. In such embodiments, the location determined by the positioning system 122 may be transmitted to the computing system 102 (e.g., in the form of location coordinates) and subsequently stored within a suitable database for subsequent processing and/or analysis.

Further, as shown in FIG. 5, the computing system 102 may also include a communications device(s) 164 to allow for the computing system 102 to communicate with an application system 40. For instance, one or more communicative links or interfaces (e.g., one or more data buses) may be provided between the communications device(s) 164 and the application system 40.

In several embodiments, the computing system 102 may be further configured to communicate via wired and/or wireless communication with one or more remote electronic devices 126 through a communications device 124 (e.g., a transceiver). The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services. The electronic device 126 may include a display for displaying information to a user. For instance, the electronic device 126 may display one or more user interfaces and may be capable of receiving remote user inputs associated with adjusting operating variables or thresholds associated with the vehicle 10. In addition, the electronic device 126 may provide feedback information, such as visual, audible, and tactile alerts, and/or allow the operator to alter or adjust one or more components, features, systems, and/or sub-systems of the vehicle 10 through the usage of the remote electronic device 126. It will be appreciated that the electronic device 126 may be any one of a variety of computing devices and may include a processor and memory. For example, the electronic device 126 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols. Additionally or alternatively, the electronic device 126 may be configured as a rate control module (RCM) and/or any other module that may be implemented within the product application system 40 and/or any other system or component of the vehicle 10.

With reference to FIGS. 4-6, the target sensor 80 may be installed or otherwise positioned on one or more boom sections of the boom assembly 38, such as by coupling the target sensor 80 to the boom assembly 38 through the one or more brackets 58. In operation, each target sensor 80 may have a field of view or detection zone 82 (e.g., as indicated by dashed lines) that is generally defined by a focal axis 84. In this regard, each target sensor 80 may be able to capture data indicative of objects and/or field conditions within its detection zone 82. For instance, in some embodiments, the target sensor 80 is feature detecting/identifying imaging devices, where the data captured by the target sensor 80 may be indicative of the location and/or type of plants and/or other objects within the field 20.

In addition, the boom assembly 38 may be configured to support a plurality of nozzle assemblies 48. Each nozzle assembly 48 may be configured to dispense an agricultural product stored within the tank 42 (FIG. 1) onto the underlying field 20. In this respect, as the work vehicle 10 travels across the field 20 in the direction of travel 18 to perform a spray operation thereon, the nozzle assemblies 48 may dispense or otherwise spray a fan 56 of the agricultural product onto one or more targets 60 within the underlying field 20.

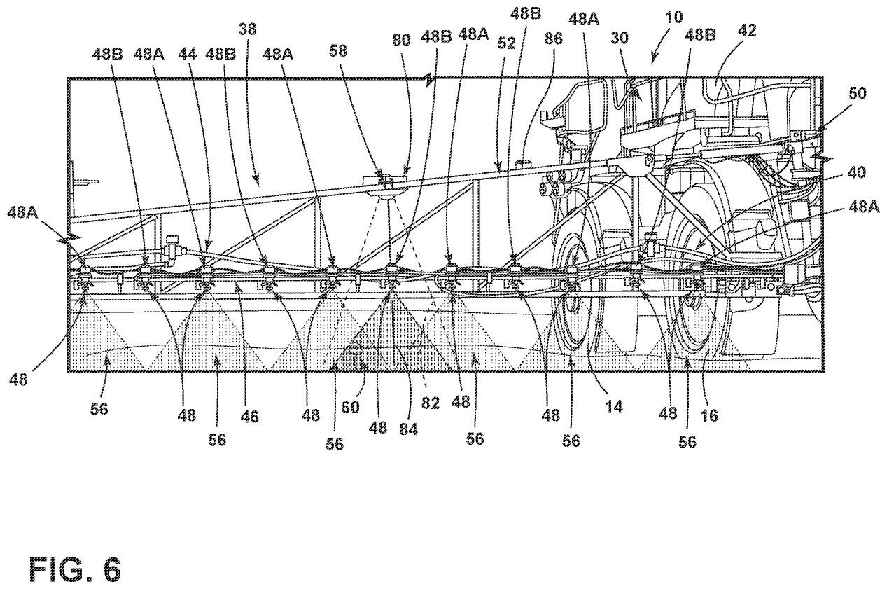

During a spray operation, the first set 48A of nozzle assemblies 48 may be configured to apply the agricultural product along the boom assembly 38 to the underlying field 20 within a defined application rate range, as generally illustrated in FIG. 5. When a target 60 is identified in the field 20, a characteristic of the target 60 may be calculated. As shown in FIG. 5, if the calculated characteristic of the target 60 is less than or equal to a defined threshold, the first set 48A of nozzle assemblies 48 may continue to exhaust the agricultural product at the defined application rate range. As shown in FIG. 6, if the calculated characteristic of the target 60 exceeds a defined threshold, at least one of the second set 48B of nozzle assemblies 48 may exhaust additional agricultural product at the target 60 to supplement the agricultural product being delivered onto the underlying field 20 by the first set 48A of nozzle assemblies 48. In some cases, a nozzle assembly 48 from the first set 48A of nozzle assemblies 48 can increase the spray rate in addition to activating a nozzle assembly 48 from the second set 48B of nozzle assemblies 48. As such, the second set 48B of nozzle assemblies 48 may be configured to intermittently dispense an agricultural product (e.g., spot spray) onto defined locations of the field 20. In such instances, the product flow and droplet size of the second set 48B of nozzle assemblies 48 may be greater than in broadcast spraying, as the product is applied at specific locations, which can reduce the risk of spray drift.

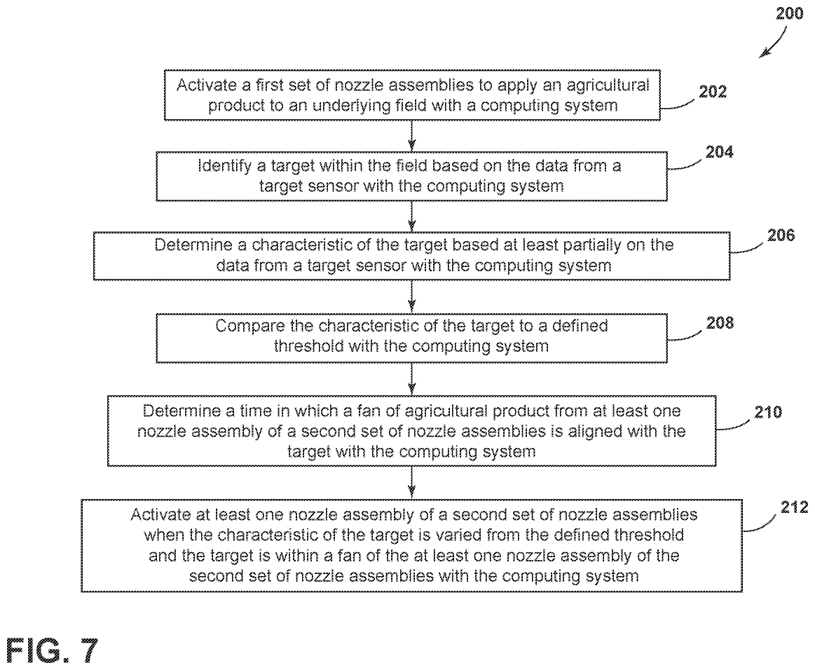

Referring now to FIG. 7, a flow diagram of some embodiments of a method 200 for an agricultural application operation is illustrated in accordance with aspects of the present subject matter. In general, the method 200 will be described herein with reference to the work vehicle 10 and the system 100 described above with reference to FIGS. 1-6. However, the disclosed method 200 may generally be utilized with any suitable agricultural work vehicle 10 and/or may be utilized in connection with a system having any other suitable system configuration. In addition, although FIG. 7 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 7, at (202), the method 200 can include activating a first set of nozzle assemblies to apply an agricultural product to an underlying field with a computing system. The agricultural product may be in the form of a solution or mixture, with a carrier (such as water) being mixed with one or more active ingredients (such as an herbicide, agricultural product, fungicide, a pesticide, or another product).

At (204), the method 200 can include identifying a target within the field based on the data from a target sensor with the computing system. As provided herein, the target sensor may be configured to capture data indicative of various features within the field. For example, the target sensor may be able to capture data indicative of objects and/or field conditions. For instance, in some embodiments, the target sensor can be feature detecting/identifying imaging devices, where the data captured by the target sensor may be indicative of the location and/or type of plants and/or other objects within the field. More particularly, in some embodiments, the data captured by the target sensor may be used to allow various objects to be detected. In some cases, the data captured may allow the computing system to distinguish weeds from useful plants within the field (e.g., crops).

At (206), the method 200 can include determining a characteristic of the target based at least partially on the data from a target sensor with the computing system. As provided herein, In various examples, the characteristic of the target can include a size of the target, a plant species (e.g., grass or broadleaf) within the target, a plant maturity of the target, a plant color (e.g., level of chlorophyll in leaves indicating vigorousness of plant) of the target, a plant location relative to crop (e.g., between corn rows or within a corn row) of the target, and/or any other identifiable characteristic. In addition, the size of the target may be a detected height of the target, a maximum width of the target, a surface area of the target, and/or any other quantifiable metric. At (208), the method 200 can include comparing the characteristic of the target to a defined threshold with the computing system. The defined threshold may be received through a user input, preloaded into the computing system, and/or generated by the computing system.

At (210), the method 200 can include determining a time in which a fan of agricultural product from at least one nozzle assembly of a second set of nozzle assemblies is aligned with the target with the computing system. In some cases, determining the time can include determining a location of the target relative to the boom assembly along a lateral direction and a position of the target to at least one nozzle assembly of the second set of nozzle assemblies in a fore-aft direction with the computing system.

At (212), the method 200 can include activating at least one nozzle assembly of a second set of nozzle assemblies when the characteristic of the target is varied from the defined threshold (possibly by greater than or less than a defined variance percentage) and the target is within a fan of the at least one nozzle assembly of the second set of nozzle assemblies with the computing system. In some cases, a combined volume of the agricultural product from at least one nozzle assembly of the first set of nozzle assemblies and at least one nozzle assembly of the second set of nozzle assemblies is greater than a maximum volume that is emitted from the at least one nozzle assembly of the first set of nozzle assemblies.

In various examples, the method 200 may implement machine learning methods and algorithms that utilize one or several vehicle learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the vehicle learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as vehicle code, which is the set of instructions and data directly executed by a computer's central processing unit or by a controller, a human-understandable form, such as source code, which may be compiled in order to be executed by a computer's central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer's central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a product application system comprising:
a first set of nozzle assemblies; and
a second set of nozzle assemblies;
a target sensor configured to capture data indicative of one or more features within a field; and
a computing system communicatively coupled to the product application system and the target sensor, the computing system being configured to:
activate the first set of nozzle assemblies to apply an agricultural product to an underlying field;
identify a target within the field based on the data from the target sensor;
determine a characteristic of the target;
compare the characteristic of the target to a defined threshold; and
activate at least one nozzle assembly of the second set of nozzle assemblies when the characteristic of the target is varied from the defined threshold and the target is within a fan of the at least one nozzle assembly of the second set of nozzle assemblies to apply a combined volume of agricultural product from the first set of nozzle assemblies and the second set of nozzle assemblies.

2. The agricultural system of claim 1, wherein the computing system is further configured to:
determine the at least one nozzle assembly of the second set of nozzle assemblies to activate based on a location of the target relative to a boom assembly.

3. The agricultural system of claim 1, wherein the computing system is configured to activate the first set of nozzle assemblies to apply the agricultural product to the field within a defined application rate range.

4. The agricultural system of claim 1, wherein the computing system is configured to activate at least one nozzle assembly of the second set of nozzle assemblies when the combined volume is greater than a maximum volume exhausted from the at least one nozzle assembly of the first set of nozzle assemblies.

5. The agricultural system of claim 1, wherein at least one nozzle assembly of the first set of nozzle assemblies and at least one nozzle assembly of the second set of nozzle assemblies are fluidly coupled with a common header.

6. The agricultural system of claim 1, wherein at least one nozzle assembly of the first set of nozzle assemblies is fluidly coupled with a first header and at least one nozzle assembly of the second set of nozzle assemblies is fluidly coupled with a second header.

7. The agricultural system of claim 1, wherein a first nozzle assembly within the second set of nozzle assemblies is positioned between first and second nozzle assemblies within the first set of nozzle assemblies.

8. The agricultural system of claim 1, wherein the characteristic of the target is a detected height of the target.

9. The agricultural system of claim 1, wherein the characteristic of the target is a detected maximum width of the target.

10. A method for an agricultural application operation, the method comprising:
activating, with a computing system, a first set of nozzle assemblies to apply an agricultural product to an underlying field;
identifying, with the computing system, a target within the field based on data from a target sensor;
determining, with the computing system, a characteristic of the target based at least partially on the data from the target sensor;
comparing, with the computing system, the characteristic of the target to a defined threshold; and
determining, with the computing system, a time in which a fan of the agricultural product from at least one nozzle assembly of a second set of nozzle assemblies is aligned with the target.

11. The method of claim 10, further comprising:
activating, with the computing system, at least one nozzle assembly of a second set of nozzle assemblies when the characteristic of the target is varied from the defined threshold and the target is within the fan of the at least one nozzle assembly of the second set of nozzle assemblies.

12. The method of claim 10, wherein determining, with the computing system, the time in which the fan of agricultural product from at least one nozzle assembly of a second set of nozzle assemblies is aligned with the target further comprises:
determining, with the computing system, a location of the target relative to the boom assembly along a lateral direction; and
determining, with the computing system, a position of the target to at least one nozzle assembly of the second set of nozzle assemblies in a fore-aft direction.

13. The method of claim 11, wherein a combined volume of the agricultural product from at least one nozzle assembly of the first set of nozzle assemblies and at least one nozzle assembly of the second set of nozzle assemblies is varied from a maximum volume that is emitted from the at least one nozzle assembly of the first set of nozzle assemblies.

14. The method of claim 10, wherein the characteristic of the target is a detected height of the target.

15. The method of claim 10, wherein the characteristic of the target is a detected maximum width of the target.

16. An agricultural system comprising:
a product application system comprising:
a first set of nozzle assemblies configured to continuously apply an agricultural product to an underlying field during a spray operation; and
a second set of nozzle assemblies;
a target sensor configured to capture data indicative of one or more features within a field; and
a computing system communicatively coupled to the product application system and the target sensor, the computing system being configured to:
identify a target within the field based on the data from the target sensor;
determine a characteristic of the target relative to a defined threshold; and
activate at least one nozzle assembly of the second set of nozzle assemblies when the characteristic of the target is varied from the defined threshold and the target is within a fan of the at least one nozzle assembly of the second set of nozzle assemblies.

17. The agricultural system of claim 16, wherein the computing system is further configured to:
determine a location of the target relative to a boom assembly.

18. The agricultural system of claim 16, wherein the target receives a combined volume of the agricultural product from the first set of nozzle assemblies and the second set of nozzle assemblies contemporaneously.

19. The agricultural system of claim 18, wherein a first volume of agricultural product exhausted from the first set of nozzle assemblies has a maximum exhausted volume.

20. The agricultural system of claim 19, wherein the combined volume is greater than the first volume.
